(19) United States
(12) Patent Application Publication
(10) Pub. No.: US 2024/0265158 A1
(43) Pub. Date: Aug. 8, 2024

(54) A DIGITAL WORKING TOOL AND METHOD INVOLVING THE SAME FOR ARCHITECTURAL PLANNING AND CONSTRUCTION

(71) Applicant: ARCHFINCH AB, Malmö (SE)

(72) Inventors: Martin KRETZ, LIMHAMN (SE); Jesper WALLGREN, MALMÖ (SE)

(21) Appl. No.: 18/562,875

(22) PCT Filed: Jul. 28, 2022
(86) PCT No.: PCT/SE2022/050732

§ 371 Date: Nov. 21, 2023

(30) Foreign Application Priority Data
Jul. 29, 2021 (SE) 2150977-3

(51) Int. Cl. G06F 30/13

(52) U.S. Cl. CPC G06F 30/13

(57) ABSTRACT

The present invention describes a digital working tool, and method, for architectural planning and construction, said digital working tool being arranged for receiving data; creating a database system with nodes and node connections wherein a node is a 2D or 3D space or an object in a 2D or 3D space or linked to a 2D or 3D space, preferably wherein a node has one or more attributes; processing a request provided to the digital working tool; and providing an output wherein at least one node or a node connection thereof has been modified or wherein at least one new node or new node connection has been created, and wherein the step of providing an output includes one or more of the following: the creation of a new node with a new node connection to an already existing node; defining a type of a new node or existing node; and/or modifying an existing node in terms of type and/or geometry.

### FIELD OF THE INVENTION

The present invention relates to a digital working tool for architectural planning and construction, and to a method therefore.

### TECHNICAL BACKGROUND

There are existing systems for architectural planning. One example is disclosed in US 2019/0228115. In US 2019/0228115 there is described a computer-implemented method for dynamically generating a digital building information model, said method comprising receiving design data on the architectural designs; encoding the design data into a graph to produce a labelled representation of objects of the design data; maintaining a knowledge base in multiple steps, receiving user input on new design projects into design models, and generating and displaying in real-time, in a layout viewport, a layout floorplan, which is generated and updated based on the user input and the knowledge base.

One aim of the present invention is to provide an efficient digital working tool and method for architectural planning and constructing, which are simple to work in and has an optimal working relationship between the digital working tool and a user operating the digital working tool.

### SUMMARY OF THE INVENTION

The stated purpose above is achieved by a digital working tool for architectural planning and construction, said digital working tool being arranged for
receiving data;
creating a database system with nodes and node connections, wherein a node is a 2D or 3D space or an object in a 2D or 3D space or linked to a 2D or 3D space, preferably wherein a node and/or link has one or more attributes;
processing a request provided to the digital working tool; and
providing an output wherein at least one node or a node connection thereof has been modified or wherein at least one new node or new node connection has been created,
   and wherein the step of providing an output includes one or more of the following:
the creation of a new node with a new node connection to an already existing node;
defining a type of a new node or existing node; and/or
modifying an existing node in terms of type and/or geometry.

As should be understood, the digital working tool according to the present invention is arranged for performing a step of presenting an output wherein at least one node or a node connection thereof has been modified or wherein at least one new node or new node connection has been created. This is a key feature according to the present invention, and differs from existing tools and methods used today.

This key feature mentioned above provides the basis for the following possibilities and advantages. The modification and/or creation of the nodes and/or node connections provide a set of graphs to enable to map a building in a way where different functions and elements are connected in a smart way. This in turn provides the following advantages:
A user may be provided with a model where complex relations are connected in a suitable way. This enables for a user to request information from the model. Furthermore, it also forms the basis of ensuring that certain requirements and specification are fulfilled, either such provided by the user or by legislation or other requirements (environmental etc.).
It also provides for enablement to assign properties and tags to spaces and objects based on relations. This in turn saves time and also forms the basis of a model based on consequent principles.
It also provides the starting point for the system and/or user, suitably via interaction, to suggest and generate geometry, objects and spaces which may be missing in a present building model.
It provides the basis for a strong interaction between the user and the system in terms of output (suggestions), which outputs may be chosen or rejected by the user, or just passively kept during the generation cycle. This and other aspects are further discussed below.

In relation to the above it may also be mentioned that the features and advantages provided above are not provided by existing systems and tools today. This is also true in the case of the method provided in US 2019/0228115.

In relation to the above it should be noted that a request may be made by a user operating a digital working tool, or may be generated automatically from the digital working tool or a connecting system or platform, e.g. when new data is provided into the digital working tool or a connecting system or platform.

In relation to the above, a “node” may be any is a 2D or 3D space or an object in a 2D or 3D space, or linked to a 2D or 3D space. Examples are a “site”, “building”, “story”, “unit”, “space”/“room”. “furniture”, “wall”, “façade”, “window”, “door”, “transition”, “elevator”, “stairs”, “HVAC element(s)”, “plumbing”, “electrical (unit(s))”, or e.g. “walking waypoints”, etc.

Furthermore, different nodes may have relations or connections to other nodes, such as e.g. that one “space” is adjacent to another “space”. Moreover, regarding “attributes”, this may refer to “type” or the like.

### SPECIFIC EMBODIMENTS OF THE INVENTION

Below some specific embodiments of the present invention are disclosed and discussed further.

According to one specific embodiment of the present invention, a node is a 2D or 3D space or an object in a 2D or 3D space, preferably wherein such a node has one or more attributes.

A node may be e.g. a certain room, like a kitchen or a living room. Such 2D or 3D spaces are defined by walls, floor, ceilings and/or other set limitations.

Moreover, an object may be e.g. a door, wall or in fact a certain furniture.

Furthermore, a node may have one or more attributes, such as the intended function, certain properties, like size, type of material or other.

According to yet another embodiment of the present invention, a node connection is a defined relationship between two nodes. Such node connections may be of different type and have different attributes and/or limitations. Examples are such defined as an adjacent node connection, e.g. between a door to a certain room, or such defining an inside connection, e.g. a certain furniture inside a certain room.

The present invention also refers to a method comprising using a digital working tool according to above, said method comprising the following steps:
receiving a request, input or data change in the digital working tool; and
providing an output wherein at least one node or a node connection thereof has been modified or wherein at least one new node or new node connection has been created.

According to the present invention, the output may be provided in different forms and this and other steps may be performed in different order. As an example, the output may be provided as a suggestion which then is actively rejected or accepted by a user. One simple example, a user first provides a room in the system and the system then suggests this room to be a kitchen by tagging this as a kitchen. It should be noted that also a passively “acceptance” from the user may be one action mode according to the present invention. This may imply that the system can continue to create more output but may delete earlier output which has not been actively accepted by the user. This may be seen as a different mode of action, or in fact no action, when compared to the user rejecting or accepting an output or suggestion provided by the system.

Furthermore, the method according to the present invention may also imply that the system provides a solution in the output which is then automatically implemented. Moreover, the platform according to the present invention also enables to draw a wall or the like without the system then proving any further suggestions. Finally, also the possibility for the user to ask for a suggestion by the system is possible according to the present invention. The system and method according to the present invention provides for a creative interaction between a user and the platform (and AI thereof) to build onto the architectural result being created.

In relation to the above with regards to drawing walls, the following may also be mentioned. The system according to the present invention suitably comprises or is connected to a drawing unit enabling to draw walls and other objects. In this context it may be mentioned that a user may draw a so called wall guide line as a starting point of an intended placing of a wall. The system may then transform this wall guide line into a node in the graph database in the system. This node is then tagged as a wall in the system according to the present invention. This is one important aspect when considering the difference between drawing wall guide lines and walls as nodes, also when reviewing the examples below.

To provide one other simple example, the following steps may be performed. A user first tags a space provided by the system as a bedroom. The system then suggests an object, such as a bed, to be placed at a certain position inside of the bedroom. The user then accepts this and moves onto drawing a new wall outside of the bedroom. The system then suggests this as a certain room and draws up a suggested room delimitation and doors etc. The user then accepts certain suggestions and may reject others.

As may be understood from above, according to one embodiment of the present invention, the step of receiving a request, input or data change implies tagging a node or creating a new node connection. Again, this may be performed by the system, or in a collaboration with a user so that some steps are made by the system and others by the user.

In relation to the above it may be mentioned that the expression “tagging” may also be seen as providing a node with a so called node attribute. As an example, a room is tagged as a bedroom, implying that it is tagged with the node attribute of room type.

Furthermore, according to yet another specific embodiment of the present invention, the step of receiving a request, input or data change implies modifying an existing node. It should be noted that combinations of the above are also possible according to the present invention.

Moreover, according to another embodiment, the step of providing an output includes the creation of a new node with a new node connection to an already existing node. As an example, a door is created between two rooms.

Furthermore, according to yet another embodiment of the present invention, the step of providing an output includes defining a type of a new node or existing node. This may imply that the function of a certain room or the like is tagged into the system, e.g. a room being a bedroom or a kitchen.

According to one specific embodiment of the present invention, the step of providing an output includes modifying an existing node in terms of type and/or geometry. This type of modification may e.g. imply that the system has an adaptive capability. As an example, the system according to the present invention may suggest a change in geometry of a certain room to fit others or the entire apartment. Moreover, also a change in function, from e.g. a type of room to another type is also totally possible.

According to yet another embodiment of the present invention, the method also comprises a step of
receiving a confirmation or denial from the user of the output wherein at least one node or a node connection thereof has been modified or wherein at least one new node or new node connection has been created.

As hinted above, this alternative is one possibility of the present invention. Here the user becomes an active part of the creation and thus decides if to accept or reject of a certain system generated suggestion. It should be noted that the level of interaction may be a parameter possible to pre-set in a system according to the present invention. If certain choices are pre-set, this may also decide if the system shall decide on certain choices automatically or should ask the user for an acceptance or rejection. As should be understood from above, this version should only be as one possible alternative of the flow of steps according to the present invention.

The method according to the present invention may also comprise graph rules. In line with this, according to one embodiment, wherein the method includes evaluating a potential output against a set rule, maximum, minimum and/or a set range to define the potential output as “allowed” or “not allowed”, and if “allowed” providing the output, and if “not allowed” presenting a notice thereof, preferably proving a reason to why “not allowed”, more preferably also providing at least one possible solution to make a change to go from “not allowed” to “allowed”.

In relation to the above it should be noted that the set rule, maximum, minimum and/or a set range may be generated manually, automatically, as in the case of the system having a form of AI operation, or by another software creating a certain graph rule. The system and method according to the present invention may be used also to validate a graph created by another software.

One example of a graph rule is e.g. a certain type of wall needed when facing a bathroom. The output to a user from the system may be a) wall X has to be of a certain type as it faces a bathroom and/or b) the system provides a change of the wall to the intended type.

Furthermore, the method according to the present invention may also comprise a selection step. According to one embodiment, the method includes performing a selection optimization from all possible outputs to at least one optimal output, preferably to a selection of a number of possible outputs, more preferably the selection optimization is performed based on one or more set parameters, more preferably based on a given shape and/or length.

The selection step according to the present invention may be seen as a filtration and/or ranking step. The method removes the choices of variants that do not fit and the other ones remaining are ranked. The shape of apartments/units are described by a polygon, i.e. a surface defined by dots connected by lines with or without holes. First, the method matches based on shape, e.g. triangular, quadratic, L-shaped etc. Then the method evaluates the need for stretching. For instance, a square variant provides by the system needs to be stretched in a rectangular apartment, so such an alternative gets a low ranking. Then also other rules may be applied and affecting the ranking of different alternatives provided by the system and method according to the present invention.

In line with the above, according to yet another embodiment, the method includes providing one or more constraints, said constrains being rules on nodes in terms of maximum or minimum values and/or possibility of change. As an alternative, a constraint may define certain limitations and/or needs for certain objects. For instance, a constraint may limit the possible stretch of a certain wall, either in terms of “not allowed to stretch”, percentage and/or distance.

Moreover, according to yet another embodiment of the present invention, the method includes performing a change of a value of one node and wherein the method provides an adaptation of at least another node based on set one or more constraints. In this case, the system and method according to the present invention actively provides an output based on a constraint.

The method according to the present invention suitably comprises repeating loops. Therefore, according to one embodiment, the method is repeating in several loops. According to one embodiment, the method is repeating so that the step of receiving a confirmation or denial of the output is continued with a new step of receiving a request, input or data change in the digital working tool.

Furthermore, also external data sources may be involved in the method according to the present invention. Therefore, according to one embodiment of the present invention, the method also involves collection of data from an external database and/or external source. To give one example here, the following steps may be performed. First, the system generates a suggestion on certain walls between spaces, such as between a bedroom and a bathroom. Then, the system collects data from an external source on suitable recipes on the components of the walls, such as tree, plaster etc. etc. A calculation may then also be made for an entire building project, and e.g. run through an EPD database, so that environmental effect may be calculated. This may then be used as an input parameter back to the system to enable for improvements, such also provided and suggested by the system and method according to the present invention.

Finally, the present invention also refers to using a method according to above, for architectural planning and construction.

### DESCRIPTION OF THE DRAWINGS

In the figures there are shown some different embodiments of the present invention.

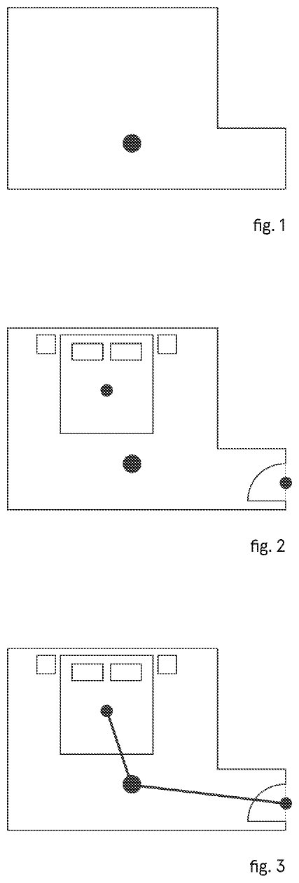

In FIGS. 1-3 there are provided a sequence according to one embodiment of the present invention. Firstly, in FIG. 1 there has been provided a node in 2D space as a starting point for this sequence. Then, as shown in FIG. 2, there is arranged new objects by the system according to the present invention. As an example, when the node is tagged as a bedroom, the system then starts suggestion an output of certain suitable objects, such as a bed, furniture and a door and placing thereof. These objects are then provided with certain node connections, as shown in FIG. 3.

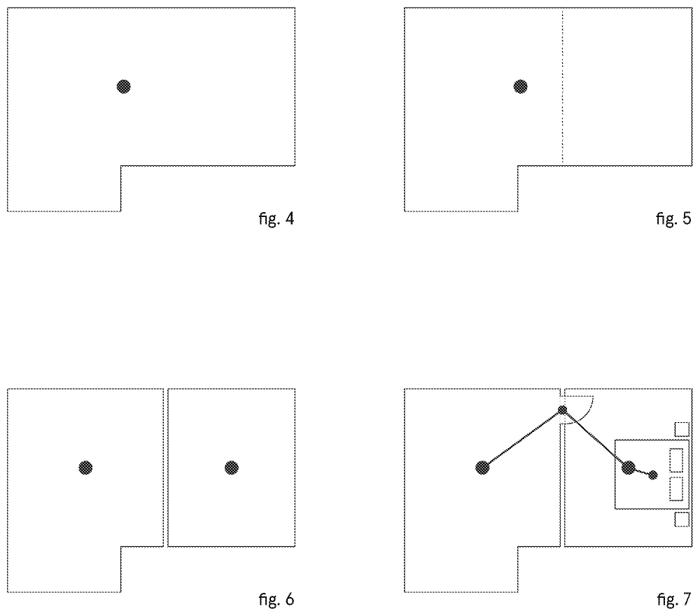

In FIGS. 4-7 there are shown one sequence according to another embodiment of the method according to the present invention. In FIG. 4 it is again shown that a system according to the present invention provides a node of a 2D space. This may be provided as a starting point for this sequence. Thereafter, a user draws a guide line as a starting point for the creation of a wall. This is shown in FIG. 5. Then, according to this embodiment, the system then provides an output of a new node, which in this case is a room as there has been created a wall. This activity is shown in FIG. 6. Thereafter, as shown in FIG. 7, the system then also tags this new node as a bedroom and then also places a suggestion of a double bed in this bedroom. In this sequence it may also be steps where the user may actively confirm the output, but this is optional.

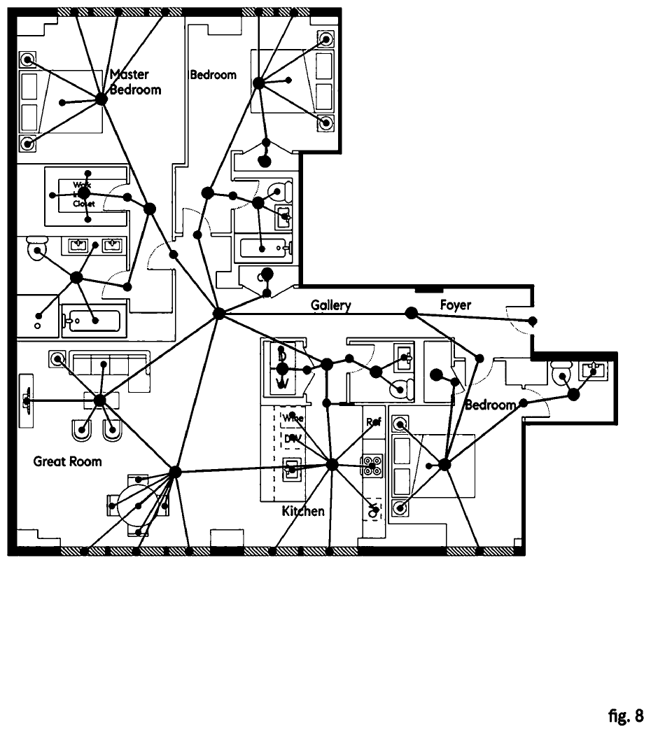

Finally, in FIG. 8 there is shown one example of an output from the system according to the present invention. Here there have been created several new nodes and objects with new node connections etc.

### EXAMPLES

Below some applications and more examples are disclosed and described further.

Firstly, below there is provided some general examples. The system and method according to the present invention may generate an output or suggestion of type of wall between two spaces, such as between two rooms. Another example is the generation of it a door should be right or left handed. Moreover, and as mentioned above, also the specific function of a certain space may be suggested. Furthermore, also other types of outputs are possible. One example is to set placement of doors or dimensions of doors based on certain input parameters, e.g. based on an estimation of the number of people visiting a building and a probable movement pattern.

Other types of interaction with other input or external data sources may be relevant for several areas, such as carbon footprint evaluation and other environmental perspectives, or for e.g. adaptation for requirements to ensure that a certain space is disabled-friendly.

Moreover, as hinted above, the system and method according to the present invention provides an interaction with a user. In this regard it may also be seen as the system operates by an AI functionality, which improves over time, such as based on the numbers of certain operations and existing data in the system.

To give some examples where this type of interaction occurs, and as a continuation of the description above, a few simple examples may be provided. In one example, a user may tag a space as a bedroom. The system then places a bed at a certain position in the bedroom, and the user may then confirm or deny this suggestion. According to yet another example it may work somewhat the other way around. The user then places a bed in a space. The system, or AI unit, then tags the space as a bedroom. In this case it may that the user then needs to accept or deny, but as said above, this may be decided based on certain pre-settings. Therefore, this last step may also be automatic.

According to yet another example, the system works with a highly output driven pre-setting and may thus suggest more based on less input. In such a case, the user confirmation of a result normally is very suitable. As an example, a user first draws up a space with some walls. The system and method may then start to work and suggest the function of the space and then also the type of walls, and may also adapt the size of the room, again based on AI training. The user then confirms of reject the suggestion.

Below, there is provided some more detailed examples.

### Example 1

This example 1 is directed to the following operations: drawing walls=>space created and suggested as bedroom with furniture=>delete walls=>space and furniture removed (since not confirmed by user)

In accordance with this example 1, the following may be performed:
1. The user draws wall guide lines (see explanation above regarding wall guide lines)
2. The system processes the input (wall guide lines together with the building and unit boundaries) where:
   it determines that the placement of one space is most likely a bedroom and suggests the type as bedroom for that space
   it adds furniture of type “double bed” to the space with a type suggested as bedroom
3. The system outputs data where:
   one new node is a space generated from the wall guide lines, with a suggested type bedroom
   one new node is a suggested piece of furniture with the type “double bed”
4. The user deletes the wall guide lines forming the previous space
5. The system processes the input where:
6. The system outputs data where:
   the previously created node for a space is removed
   the previously crated node for a piece of furniture is removed

### Example 2

This example 2 is directed to the following operations: drawing walls=>space created and suggested “bedroom” with furniture added=>change furniture type=>delete walls=>space removed, and furniture (since confirmed by editing)

In accordance with this example 2, the following may be performed:
1. The user draws wall guide lines (see above)
2. The system processes the input (wall guide lines together with the building and unit boundaries) where:
   it determines that the placement of one space is most likely a bedroom and suggests the type as bedroom for that space
   it adds furniture of type “double bed” to the space with a type suggested as bedroom
3. The system outputs data where:
   one new node is a space generated from the wall guide lines, with a suggested type bedroom
   one new node is a suggested piece of furniture with the type “double bed”
4. The user edits the furniture node to type “single bed”
5. The user deletes the wall guide lines forming the previous space
6. The system processes the input
7. The system outputs data where:
   the previously created node for a space is removed
   the previously created node for a piece of furniture is kept (not longer a pure suggestion, since actively edited by user)

### Example 3

This example 3 is directed to the following operations: Drawing unit wall=>space created and door placement and type suggested=>drawing inner wall=>space created and door placement and type suggested In accordance with this example 3, the following may be performed:
1. The user draws unit walls
2. The system processes input where:
   a new node for the wall enclosed unit is created
   a new node for the front door is created, where suggested wall placement, door type (fire door since adjacent to stair well), and opening direction (out) is determined by an algorithm.
3. The user draws inner walls
4. The system processes input where:
   a new node for the inner spaces are created
   a new node for the door is created, where suggested wall placement, door type (regular inner door), opening direction (in) determined by algorithm.

### Example 4

This example 4 relates to the possible use of constraints and stretch in a method according to the present invention.

Data included in an architectural plan (polygon and graph) is prepared in the form of points and relationships between points. This forms the basis of the graph and equations in this embodiment. In this example constraints for walls are set in different alternatives: some are possible to stretch but kept with the same direction/angle; others are not allowed to be changed. Here it should be noted that other rules may apply, such as all walls are stretched the same in X or Y, the same proportion of stretch are made for all walls, and/or other constraints are limitations being applied for some walls.

These constraints are then used in the method according to the present invention to provide for new points once the constraints have been applied to the graph. In this example, an algorithm Cassowary was used in the method according to the present invention, with constraints expressed as equations. Other algorithms may of course be used instead.

1. A digital working tool for architectural planning and construction, said digital working tool being arranged for
receiving data;
creating a database system with nodes and node connections, wherein a node is a 2D or 3D space or an object in a 2D or 3D space or linked to a 2D or 3D space, preferably wherein a node has one or more attributes;
processing a request provided to the digital working tool; and
providing an output wherein at least one node or a node connection thereof has been modified or wherein at least one new node or new node connection has been created,
and wherein the step of providing an output includes one or more of the following:
the creation of a new node with a new node connection to an already existing node;
defining a type of a new node or existing node; and/or
modifying an existing node in terms of type and/or geometry.

2. The digital working tool according to claim 1, wherein a node is a 2D or 3D space or an object in a 2D or 3D space.

3. The digital working tool according to claim 1, wherein a node connection is a defined relationship between two nodes.

4. A method comprising using a digital working tool according to claim 1, said method comprising the following steps:
receiving a request, input or data change in the digital working tool; and
providing an output wherein at least one node or a node connection thereof has been modified or wherein at least one new node or new node connection has been created and wherein the step providing an output includes one or more of the following:
the creation of a new node with a new node connection to an already existing node;
defining a type of a new node or existing node; and/or
modifying an existing node in terms of type and/or geometry.

5. The method according to claim 4, wherein the step of receiving a request, input or data change implies tagging a node or creating a new node connection.

6. The method according to claim 4, wherein the step of receiving a request, input or data change implies modifying an existing node.

7. The method according to claim 4, wherein the step of providing an output includes the creation of a new node with a new node connection to an already existing node.

8. The method according to claim 4, wherein the step of providing an output includes defining a type of a new node or existing node.

9. The method according to claim 4, wherein the step of providing an output includes modifying an existing node in terms of type and/or geometry.

10. The method according to claim 4, wherein the method also comprises a step of
receiving a confirmation or denial from the user of the output wherein at least one node or a node connection thereof has been modified or wherein at least one new node or new node connection has been created.

11. The method according to claim 4, wherein the method includes evaluating a potential output against a set rule, maximum, minimum and/or a set range to define the potential output as “allowed” or “not allowed”, and if “allowed” providing the output, and if “not allowed” presenting a notice thereof, preferably proving a reason to why “not allowed”, more preferably also providing at least one possible solution to make a change to go from “not allowed” to “allowed”.

12. The method according to claim 4, wherein the method includes performing a selection optimization from all possible outputs to at least one optimal output, preferably to a selection of a number of possible outputs, more preferably the selection optimization is performed based on one or more set parameters, more preferably based on a given shape and/or length.

13. The method according to claim 4, wherein the method includes providing one or more constraints, said constrains being rules on nodes in terms of maximum or minimum values and/or possibility of change.

14. The method according to claim 13, wherein the method includes performing a change of a value of one node and wherein the method provides an adaptation of at least another node based on set one or more constraints.

15. The method according to claim 4, wherein the method is repeating in several loops.

16. The method according to claim 10, wherein the method is repeating so that the step of receiving a confirmation or denial of the output is continued with a new step of receiving a request, input or data change in the digital working tool.

17. The method according to claim 4, wherein the method also involves collection of data from an external database and/or external source.

18. A method comprising using the method according to claim 4, for architectural planning and construction.
